(19) United States
(12) Patent Application Publication
(10) Pub. No.: US 2012/0186343 A1
(43) Pub. Date: Jul. 26, 2012

(54) Method for balancing a rotor mounted on a hub of a wind turbine

(76) Inventor: Per Egedal, Herning (DK)

(21) Appl. No.: 13/497,075

(22) PCT Filed: Sep. 21, 2009
(86) PCT No.: PCT/EP2009/062192

§ 371 Date: Mar. 20, 2012

(51) Int. Cl. G01M 1/22; G01M 1/32

(52) U.S. Cl. 73/455

(57) ABSTRACT

It is described a method for balancing a rotor mounted on a hub of a wind turbine. The method includes measuring a parameter value of a parameter being indicative of the revolution frequency components of the rotor and/or of a generator of the wind turbine during operation of the wind turbine, calculating a change of the spatial mass distribution of the rotor based on the parameter value of the parameter, which change is needed for balancing the rotor, and balancing the spatial mass distribution of the rotor by using at least one balancing weight element being attachable to at least one blade of the rotor based on the calculated change of the spatial mass distribution. It is further described a system for balancing a rotor, a wind turbine, a computer program and a computer-readable medium, which are all adapted for carrying out the above described balancing method.

### FIELD OF INVENTION

The present invention relates to the technical field of balancing power generating machines such as wind turbines. In particular, the present invention relates to a method and to a system for balancing a rotor mounted on a hub of a wind turbine in such a manner that balancing can be realized when the rotor is already mounted on the hub. Further, the present invention relates to a wind turbine, to a computer program and to a computer-readable medium, which are adapted for carrying out the above mentioned balancing method.

### ART BACKGROUND

When rotors of wind turbines are mounted on a hub, they may may turn out to be unbalanced at the installation of the wind turbine. The unbalance may be caused by differences in blade weight, or more precisely the blade root bending moment caused by gravity. When operating with an unbalanced rotor a wind turbine will experience higher structural loads than when operating with a balanced rotor.

A common method to eliminate an unbalance is to weigh the blades out individually before they are mounted on the hub. Differences in weight are solved by placing weight blocks in the blades so the root bending moment is equal for the three blades on a rotor.

There may be a need for providing a flexible balancing procedure for balancing a rotor already mounted on a hub of a wind turbine, which procedure is capable of taking into account different input parameters for realizing an efficient balancing operation with respect to the spatial mass distribution of the rotor blades.

### SUMMARY OF THE INVENTION

This need may be met by the subject matter according to the independent claims. Advantageous embodiments of the present invention are described by the dependent claims.

According to a first aspect of the invention there is provided a method for balancing a rotor mounted on a hub of a wind turbine. The provided method comprises measuring a parameter value of a parameter being indicative of the revolution frequency components of the rotor and/or of a generator of the wind turbine during operation of the wind turbine, calculating a change of the spatial mass distribution of the rotor based on the parameter value of the parameter, which change is needed for balancing the rotor, and balancing the spatial mass distribution of the rotor by using at least one balancing weight element being attachable to at least one blade of the rotor based on the calculated change of the spatial mass distribution.

The described method is based on the idea that rotor blades mounted on a hub of a wind turbine may be in unbalance. It is assumed that there is no or only small relationship between unbalance and blade forms, blade positions, tower frequency or blade serial number. An unbalance may occur when the spatial mass distribution of the rotor blades is different for each rotor blade mounted on the rotor or if the spatial mass distribution is not balanced for the whole system comprising the rotor blades. By using balancing weight elements, the spatial mass distribution may be adjusted in such a manner that the rotor is in balance.

To calculate the change of the spatial mass distribution, which change is needed for balancing the rotor, a parameter value may be measured, wherein the parameter is indicative of the revolution frequency components of the rotor and/or the generator. The measurement may be carried out during operation of the wind turbine.

The change of the spatial mass distribution may be calculated for each relevant blade. Then, the corresponding balancing weight elements or weight blocks may be used. The method may be used after turbines are erected. This means that the turbine can be balanced if the weight of the blades has changed for some reason for example repairing. It may also be used for balancing the rotor if one blade has been exchanged.

According to an embodiment of the invention, using at least one balancing weight element comprises at least one of adding at least one balancing weight element to at least one blade of the rotor, changing the position of at least one balancing weight element or removing at least one balancing weight element from at least one blade of the rotor.

The balancing weight elements or weight blocks may be placed inside each blade in a chosen distance from the centre of the hub. Also the position in relation to the centre of the hub may be changed.

According to a further embodiment of the invention, measuring a parameter value of the parameter comprises determining a value of a first harmonic of the revolution frequency of the rotor and/or generator speed.

The 1P level or value is the first harmonic of the rotor or generator revolution frequency. The 1P level in for example the generator speed may have a magnitude and a phase angle with respect to the blade position. Thus, the parameter value may be a pair of parameter values comprising a phase angle and a magnitude.

According to a further embodiment of the invention, the parameter is a mean value of the value of the first harmonic over a predefined time period.

The parameter value may be measured for example over 10 minutes, or as a function of the mean value. Small values could have a longer filter time. Subsequently, a mean value of the parameter value may be calculated, wherein the parameter value may be a complex value with the phase angle and magnitude referring to the rotor azimuth.

According to a further embodiment of the invention, calculating a change of the spatial mass distribution of the rotor based on the parameter value of the parameter comprises simulating a change of the mass distribution, measuring a further parameter value being indicative of the revolution frequency of the rotor and/or generator of the wind turbine for simulation, calculating a difference between a function value of the parameter value and a function value of the further parameter value, and calculating the change of the spatial mass distribution of the rotor based on the calculated difference.

The change of the mass distribution may also be carried out by field test. In this case, measuring a further parameter value may be done during the field tests.

By measuring the parameter value, complex 1P values may be measured and subsequently filtered and for example the 10 min. mean values are calculated. The following method may then be used to find the needed weight elements to balance the rotor of the wind turbine:
1. Measure the 1P mean level (magnitude and phase with respect to the rotor azimuth)
   a. Plot the data as a function of rotor speed
   b. Find a normalizing function to get all data at the same magnitude and phase
   c. Calculate complex mean value U_0
2. Place weight blocks or elements in the blade of a test turbine or by simulation
   a. Calculate the complex weight change on the blade M_1
3. Measure the 1P mean level with the new weight block configuration
   a. Use the same normalizing function as in 1b
   b. Calculate complex mean value U_1
4. Calculate the difference in unbalance
   a. Udiff=U_1−U_0
5. Calculate a transfer function from unbalance to weight change
   a. T=M_1/Udiff
6. This transfer function may now be used to calculate the needed weight change to balance the rotor
   a. Mbal=U_1*T
   b. Calculate weight block for individual blade using the inverse Clarke transformation
7. Weight block for other similar turbines may now be calculated as a function of their complex normalized 1P level and the transfer function

When the weight changes has been calculated for each relevant blade, then the corresponding weight blocks may be placed inside each blade in a chosen distance from the centre of the hub.

According to a further embodiment of the invention, the method comprises further storing the parameter value in a controller of the wind turbine, wherein calculating the change of the spatial mass distribution is carried out in the controller.

The measured parameter value or values may also be stored in a controller responsible for a complete wind park with a plurality of wind turbines. By storing the parameter value, it may be easy to reuse the measured values when a change of blades has been carried out.

According to a further embodiment of the invention, the value of a first harmonic of the revolution frequency of the rotor and/or generator speed is determined by a Goertzel algorithm or Fast Fourier Transformation.

The Goertzel algorithm may output the level or value of the first harmonic (1P) every rotor revolution as a complex value with the phase angle referring to the rotor azimuth. By using Fast Fourier Transformation, also the further harmonics nP, wherein n>=1 may be found.

According to a further aspect of the invention there is provided a system for balancing a rotor mounted on a hub of a wind turbine. The provided system comprises a measuring unit for measuring a parameter value of a parameter being indicative of the revolution frequency components of the rotor and/or of a generator of the wind turbine during operation of the wind turbine, a calculation unit for calculating a change of the spatial mass distribution of the rotor based on the parameter value of the parameter, which change is needed for balancing the rotor, and a balancing unit for balancing the spatial mass distribution of the rotor by using at least one balancing weight element being attachable to at least one blade of the rotor based on the calculated change of the spatial mass distribution.

Also the described system is based on the idea that rotor blades mounted on a hub of a wind turbine may be in unbalance and that such an unbalance may be measured during operation. Subsequently, the unbalance may be eliminated by using balancing weight elements.

According to a further aspect of the invention there is provided a wind turbine, which comprises a system for balancing a rotor mounted on a hub of the wind turbine as described above.

The wind turbine may comprise the system for example within a controller or computer. Thus, stored values may be reused for further balancing.

According to a further aspect of the invention there is provided a computer program for balancing a rotor mounted on a hub of a wind turbine. The computer program, when being executed by a data processor, is adapted for controlling the above described method for balancing a rotor mounted on a hub of a wind turbine.

As used herein, reference to a computer program is intended to be equivalent to a reference to a program element containing instructions for controlling a computer system to coordinate the performance of the above described method.

The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

According to a further aspect of the invention there is provided a computer-readable medium (for instance a CD, a DVD, a USB stick, a floppy disk or a hard disk), in which a computer program for balancing a rotor mounted on a hub of a wind turbine is stored, which computer program, when being executed by a processor, is adapted to carry out or control a method for balancing a rotor mounted on a hub of a wind turbine.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION OF THE DRAWINGS

FIG. 1 shows a system according to an embodiment of the present invention.

FIGS. 2a and 2b show a 1P level with 38.5 kg weight blocks placed on all blades.

FIG. 3a shows a plot of the mean values of the 1P level.

FIG. 3b shows the difference in mean values between normal operation and operation with weight block.

FIG. 3c shows the relation between weight blocks placed in the blades and the 1P level in the generator speed.

### DETAILED DESCRIPTION

The illustration in the drawing is schematically. It is noted that in different figures, similar or identical elements are provided with the same reference signs or with reference signs, which are different from the corresponding reference signs only within the first digit.

Wind turbine rotors may turn out to be unbalanced at the installation of the wind turbine. The unbalance may be caused by differences in blade weight (more precisely, the blade root bending moment caused by gravity). When operating with an unbalanced rotor a wind turbine will experience higher structural loads than when operating with a balanced rotor.

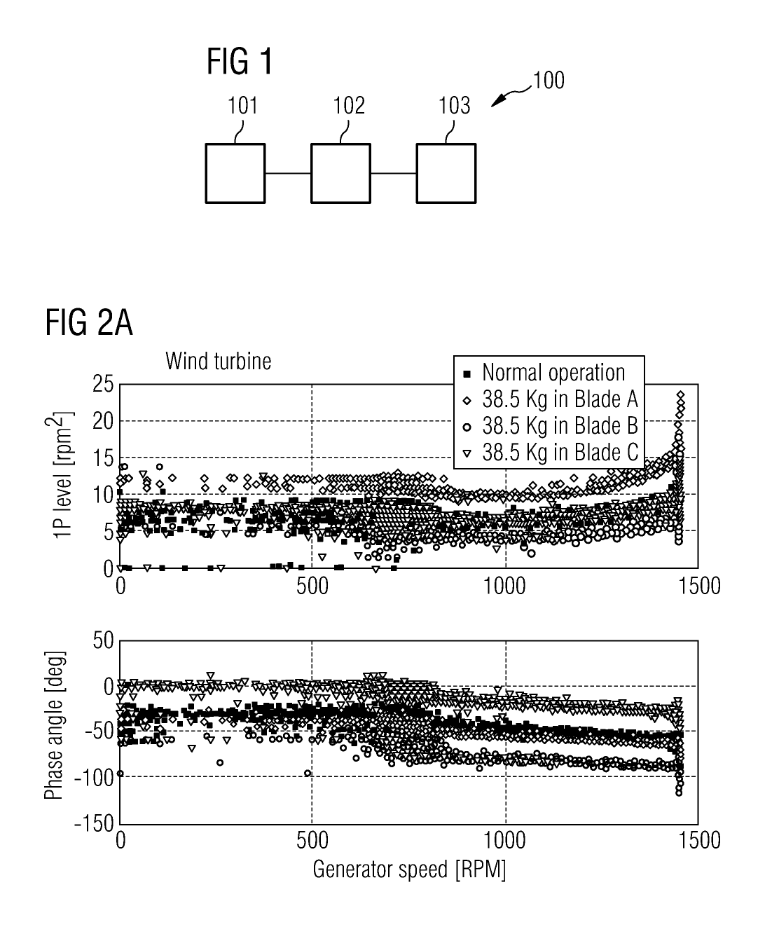

FIG. 1 shows an exemplary embodiment according to the invention. The system 100 comprises a measuring unit 101, a calculation unit 102 and a balancing unit 103. The 1P level of the generator or rotor speed, measured in the measuring unit, is logged in a controller or computer of a wind turbine using a Göertzel algorithm. Also a Fast Fourier Transformation (FFT) could be used whereby the nP level could be found, where n>=1, if this should be considered to be relevant. The Goertzel algorithm outputs the 1P level every rotor revolution as a complex value with the phase angle referring to the rotor azimuth. The complex 1P values are then filtered and for example the 10 min. mean values are calculated and stored in the controller or computer. This calculation and data storing could be done in different controllers or computers in the wind turbine and/or in a wind park computer/server.

The following method is then used to find the needed weights to balance the rotor of the wind turbine:
1. Measure the 1P mean level (magnitude and phase with respect to the rotor azimuth)
   a. Plot the data as a function of rotor speed
   b. Find a normalizing function to get all data at the same magnitude and phase
   c. Calculate complex mean value U_0
2. Place weight blocks or elements in the blade of a test turbine or by simulation
   a. Calculate the complex weight change on the blade M_1
3. Measure the 1P mean level with the new weight block configuration
   a. Use the same normalizing function as in 1b
   b. Calculate complex mean value U_1
4. Calculate the difference in unbalance
   a. Udiff=U_1−U_0
5. Calculate a transfer function from unbalance to weight change
   a. T=M_1/Udiff
6. This transfer function may now be used to calculate the needed weight change to balance the rotor
   a. Mbal=U_1*T
   b. Calculate weight block for individual blade using the inverse Clarke transformation
7. Weight block for other similar turbines may now be calculated as a function of their complex normalized 1P level and the transfer function

When the weight changes has been calculated for each relevant blade, then the corresponding weight blocks can be placed inside each blade in a chosen distance from the centre of the hub.

With this method or system, the rotor of a wind turbine is balanced by measuring the 1P component of the generator or rotor speed and calculating the needed weight changes to balance the rotor. The method can be used after turbines are erected. This means that the turbine can be balanced if the weight of the blades has changes for some reason for example repairing. It can also be used for balancing the rotor if one blade has been exchanged.

In the following, an example from a test wind park site is described. It deals with an analysis of the rotor unbalance of a test wind turbine and a test wind park. The method for measuring the unbalance is introduced and different plots and statistical data for an exemplary rotor unbalance at an exemplary test wind park are described.

The rotor unbalance is calculated, based on three experiments on a wind turbine and one month of data from a whole test wind park.

Based on the data from this analysis it can be concluded that there is no relationships between unbalance and blade forms and blade positions (A,B,C). There is also no or a very little link between unbalance and tower frequency and blade serial number.

Now the method for measuring of rotor mass unbalance is described. The 1P level in the generator speed is logged in the hub computer using a Goertzel algorithm. The Goertzel algorithm outputs the 1P level every rotor revolution as a complex value with the phase angle referring to the rotor azimuth. The complex 1P values are filtered in the main controller and the 10 min. mean values are calculated by the Ibox and stored in the scientific database at the park server.

The relation between 1P generator speed in low wind and rotor mass unbalance is found by experiments using a wind turbine where 38.5 kg is placed in one blade at a time to measure the change in the 1P level in the generator speed.

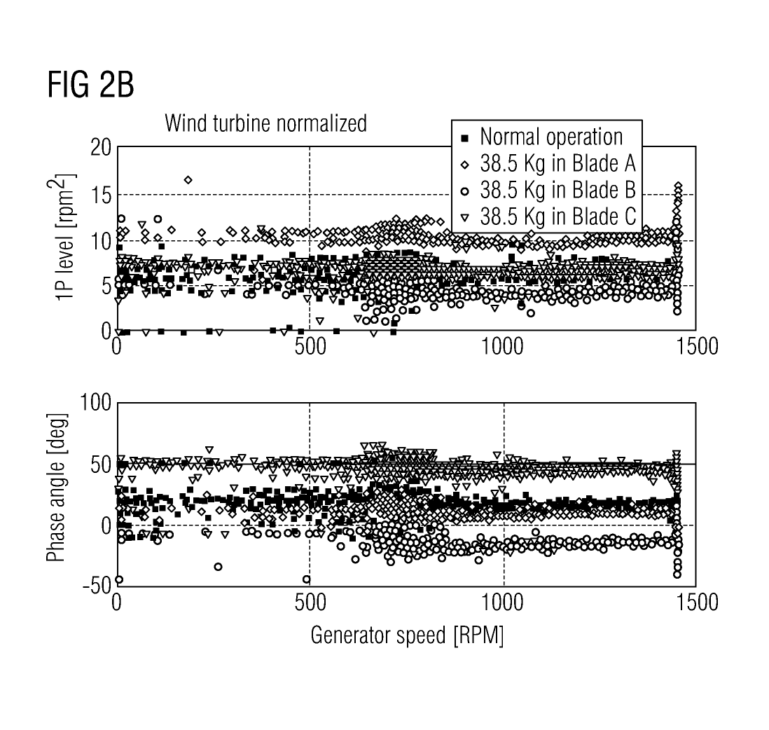

The FIGS. 2a and 2b show the 1P level with 38.5 kg weight blocks placed on all blades (one at a time). FIG. 2a shows raw data. FIG. 2b shows normalized data. This normalizing function is used to normalize data for a whole park to be more independent on different wind speeds.

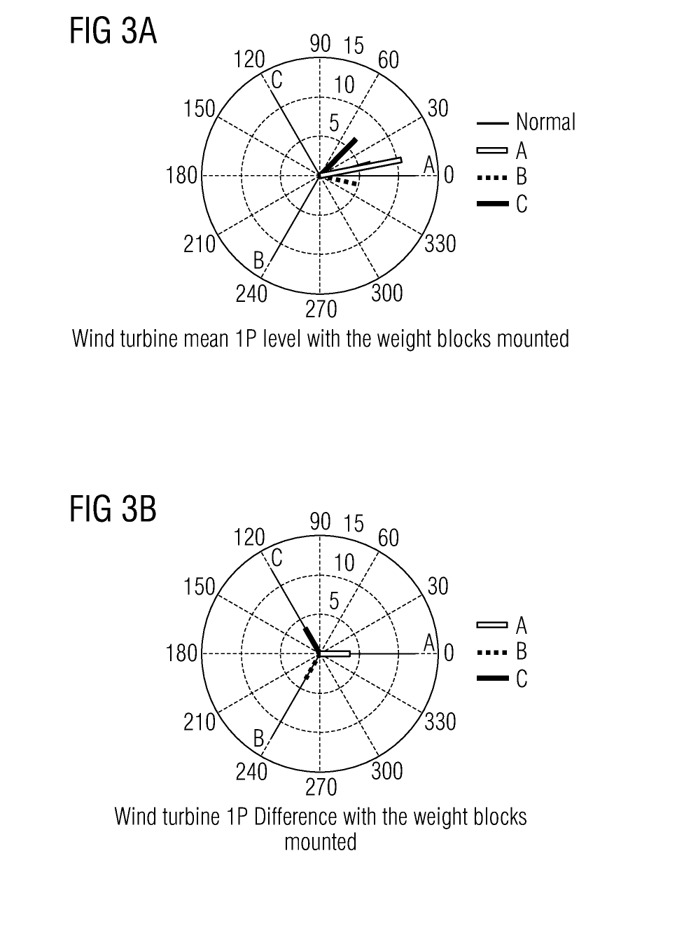

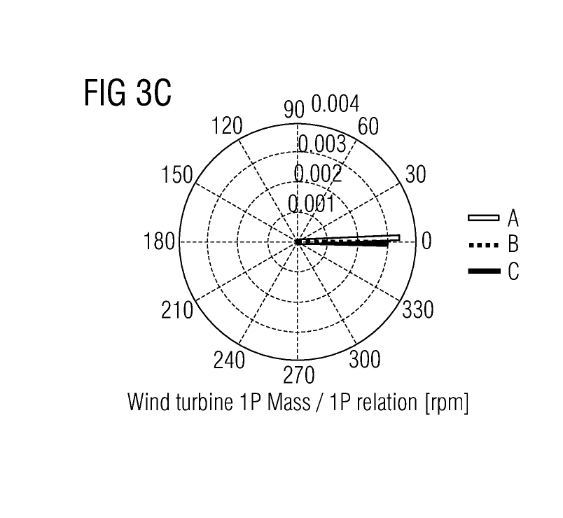

FIG. 3a shows a plot of the mean values of the 1P level. FIG. 3b shows the difference in mean values between normal operation and operation with weight block. The plots show that the change in 1P level is the same when the weight blocks is moved from one blade to another and the phase angle changes 120 degrees. One can therefore conclude that there is a clear linear relationship between mass unbalance and normalized 1P level in the generator speed.

FIG. 3c shows the relation between weight blocks placed in the blades and the 1P level in the generator speed. It is clear that the relations from the three different weight block setup are very equal. The mean value of these relations is used to calculate the mass unbalance on the whole site.

The following deals with different statistical data for rotor unbalance at a test wind park site. In the following table, an exemplary overview of unbalances of different wind turbines is shown.

| Turbine | Max Un- | Unbal- | Unbal- | Unbal- | Block | Block | Block |
|---|---|---|---|---|---|---|---|
| ID | balance | ance A | ance B | ance C | A | B | C |
| 1 | 840 | 0 | 819 | 840 | 0 | 1 | 1 |
| 2 | 883 | 310 | 883 | 0 | 0 | 1 | 0 |
| 3 | 915 | 0 | 536 | 915 | 0 | 1 | 1 |
| 4 | 936 | 936 | 0 | 634 | 2 | 0 | 1 |
| 5 | 951 | 951 | 63 | 0 | 2 | 0 | 0 |
| 6 | 1009 | 1009 | 0 | 476 | 2 | 0 | 1 |
| 7 | 1042 | 1042 | 0 | 73 | 2 | 0 | 0 |
| 8 | 1072 | 0 | 663 | 1072 | 0 | 1 | 2 |
| 9 | 1072 | 0 | 1072 | 153 | 0 | 2 | 0 |
| 10 | 1101 | 1101 | 578 | 0 | 2 | 1 | 0 |
| 11 | 1154 | 0 | 1154 | 96 | 0 | 2 | 0 |
| 12 | 1188 | 0 | 1188 | 421 | 0 | 2 | 1 |
| 13 | 1281 | 0 | 1281 | 1255 | 0 | 2 | 2 |

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1-11. (canceled)

12. A method for balancing a rotor mounted on a hub of a wind turbine, the method comprising:
measuring a parameter value of a parameter being indicative of the revolution frequency components of the rotor and/or of a generator of the wind turbine during operation of the wind turbine;
calculating a change of the spatial mass distribution of the rotor based on the parameter value of the parameter, which change is needed for balancing the rotor; and
balancing the spatial mass distribution of the rotor by using at least one balancing weight element being attachable to at least one blade of the rotor based on the calculated change of the spatial mass distribution.

13. The method as set forth in claim 12,
wherein using at least one balancing weight element comprises at least one of adding at least one balancing weight element to at least one blade of the rotor, changing the position of at least one balancing weight element or removing at least one balancing weight element from at least one blade of the rotor.

14. The method as set forth in claim 13,
wherein measuring a parameter value of the parameter comprises determining a value of a first harmonic of the revolution frequency of the rotor and/or generator speed.

15. The method as set forth in claim 12,
wherein measuring a parameter value of the parameter comprises determining a value of a first harmonic of the revolution frequency of the rotor and/or generator speed.

16. The method as set forth in claim 14,
wherein the parameter is a mean value of the value of the first harmonic over a predefined time period.

17. The method as set forth in claim 15,
wherein the parameter is a mean value of the value of the first harmonic over a predefined time period.

18. The method as set forth in claim 12,
wherein calculating a change of the spatial mass distribution of the rotor based on the parameter value of the parameter comprises:
simulating a change of the mass distribution,
measuring a further parameter value being indicative of the revolution frequency of the rotor and/or generator of the wind turbine for simulation,
calculating a difference between a function value of the parameter value and a function value of the further parameter value, and
calculating the change of the spatial mass distribution of the rotor based on the calculated difference.

19. The method as set forth in claim 12, further comprising
storing the parameter value in a controller of the wind turbine, wherein calculating the change of the spatial mass distribution is carried out in the controller.

20. The method as set forth in claim 15,
wherein the value of a first harmonic of the revolution frequency of the rotor and/or generator speed is determined by a Goertzel algorithm or Fast Fourier Transformation.

21. A system for balancing a rotor mounted on a hub of a wind turbine, the system comprising:
a measuring unit for measuring a parameter value of a parameter being indicative of the revolution frequency components of the rotor and/or of a generator of the wind turbine during operation of the wind turbine;
a calculation unit for calculating a change of the spatial mass distribution of the rotor based on the parameter value of the parameter, which change is needed for balancing the rotor; and
a balancing unit for balancing the spatial mass distribution of the rotor by using at least one balancing weight element being attachable to at least one blade of the rotor based on the calculated change of the spatial mass distribution.

22. A wind turbine comprising:
a system for balancing a rotor mounted on a hub of the wind turbine as set forth in claim 21.

23. A computer-readable medium, in which a computer program for balancing a rotor mounted on a hub of a wind turbine is stored, which computer program, when being executed by a processor, is configured to carry out the method as set forth in claim 12.
